(19) United States
(12) Patent Application Publication
(10) Pub. No.: US 2004/0020723 A1
(43) Pub. Date: Feb. 5, 2004

(54) Method and system of providing a product in a refillable container and a refillable container

(76) Inventors: Allan L. Schuman, Eden Prairie, MN (US); Tina O. Outlaw, Inver Grove Heights, MN (US); Bryan M. Anderson, St. Paul, MN (US); Keith E. Olson, Apple Valley, MN (US)

Correspondence Address: IPLM GROUP, P.A., POST OFFICE BOX 18455, MINNEAPOLIS, MN, 55418, US

(21) Appl. No.: 10/434,392

(22) Filed: May 8, 2003

Related U.S. Application Data
(60) Provisional application No. 60/379,881, filed on May 10, 2002.

(51) Int. Cl. B61B 1/00; B65G 1/00; E04H 3/00

(52) U.S. Cl. 186/52

(57) ABSTRACT

A method for creating ready-to-use products from a concentrated form of the products for sale at a retail price is disclosed. The apparatus to create the ready-to-use products generally comprises a source of one or more concentrated products. These concentrated products are delivered to a point of use which typically may be a small, consumer-sized container. The apparatus dilutes the concentrated product to an appropriate level. The final, ready-to-use product can be a wide variety of cleaning products. The method provides for a larger profit to the retailer than normally available from the sale of pre-filled cleaning products.

### RELATED APPLICATION

This application claims priority from provisional U.S. patent application Ser. No. 60/379,881, Method of Using a Multi-Use Dilution System, filed May 10, 2002, in the name of Allan L. Schuman, Tina O. Outlaw and Bryan M. Anderson (Attorney Docket No. 117P73USP1).

### TECHNICAL FIELD

The invention is generally related to a method of using an onsite apparatus to prepare aqueous cleaning compositions and in particular, a method for use in a commercial establishment, such as a retail store, selling product as an alternative to a prefilled price.

### BACKGROUND

There have been numerous dilution systems developed and patented over the years. These dilution systems come in a variety of formats, but typically take a concentrated liquid and create a ready-to-use product through the addition of water. Examples of patents directed to this general concept include the following: U.S. Pat. Nos. 4,976,137; 5,203,366; 5,259,557; 5,344,074, 5,584,327; 5,597,019; 5,810,201; 5,651,398; 5,746,238; 5,655,563; 5,738,135; 5,799,831; 5,832,972; 5,816,446; 5,915,592; 5,961,011; 6,056,012; 6,079,595.

However, to date, there has not been an adequate system wherein a consumer can readily activate a dispensing system which delivers a ready to use product to a container in a safe and economical manner.

The use of one use, pre-filled containers is also environmentally unsound. The containers are used only once and extra energy is used to transport water, which is a large portion of most ready-to-use products.

It is also difficult to price such pre-filled and refilled containers using standard, commonly used equipment normally found at commercial establishment checkout stations. If the user, e.g., a consumer, is expected to bring the container back to the commercial establishment for refilling, the customer should receive an economic incentive. However, with products commonly being simply scanned at checkout by a laser reader, any scannable code placed on the container suitable for sale with initial fill would be inappropriate for sale upon refilling.

### SUMMARY OF THE INVENTION

In one embodiment, the invention is a method of providing a retail product in a container to a consumer from a retail store operated by a retailer. The retail product is a liquid constructible from a concentrate. The retail product is an alternative to a pre-filled product sold at a retail store at a pre-fill price. A method includes the steps of supplying the concentrate to the retail store. Obtaining water locally with respect to the retail store. The container is filled at the retail store with the retail product using a combination of the concentrate and water. The retail product is sold to the consumer at a retail price which is below a pre-filled price. The retailers provided with a portion of the retail price, the portion of the retail price being larger than a portion of the pre-filled price available to the retailer from sales of the pre-filled product. In one embodiment, the water is available locally and further, the containers may be recyclable, both of which are environmental improvements.

In a preferred embodiment, the invention further conditions the water.

In a preferred embodiment, the filling step is accomplished by the consumer.

In a preferred embodiment, the filling step is accomplished at a retail kiosk in the retail store.

In a preferred embodiment, the concentrate is a liquid concentrate.

In a preferred embodiment, the retail product is a liquid product.

In a preferred embodiment, the liquid product is a cleaning product.

In a preferred embodiment, the invention has an additional step of providing promotional material to the consumer during the filling step and from the retail kiosk.

In a preferred embodiment, the invention has an additional step of providing promotional material to the consumer while the filling step is being accomplished.

In a preferred embodiment, the retail product is sold at a retail price which is below the pre-filled price.

In another embodiment, the present invention provides a refillable container adapted to be initially sold at a commercial establishment and subsequently be refilled at a commercial establishment. A refillable container is provided with an identifier associated with the refillable container. The identifier has a first condition indicative of the refillable container and a second condition indicative of refilling of the container.

In another embodiment, the present invention provides a system for providing a product in a refillable container at a commercial establishment. An identifier is associated with the refillable container. The identifier has a first condition indicative of the refillable container and a second condition indicative of refilling of the container. A dispenser is adapted to receive the refillable container and is capable of filling the refillable container with the product. A reader is capable of reading the identifier. The system is configured such that the reader reads the identifier in the first condition when the refillable container is initially provided with the product and reads the identifier in the second condition when the refillable container is provided having been refilled with the product.

In another embodiment, the present invention provides a method of providing a product in a refillable container at a commercial establishment. The refillable container is associated with an identifier having a first condition indicative of the refillable container and a second condition indicative of refilling of the refillable container. The refillable container is initially filled with the product. The identifier representative of the first condition is read and a price is determined for the refillable container containing the product. The refillable container is refilled with the product. The identifier representative of the second condition is read and a price is determined for the refilled container.

In a preferred embodiment, identifier is a first scannable code associated with the refillable container indicative of the first condition and a second scannable code associated with the refillable container indicative of the second condition.

In a preferred embodiment, the identifier is a scannable code.

In a preferred embodiment, the first scannable code is superimposed over the second scannable code.

In a preferred embodiment, the first scannable code is on a removable label associated with the refillable container.

In a preferred embodiment, the removable label is a coupon.

In a preferred embodiment, the removable label is superimposed over the second scannable code.

In a preferred embodiment, the second scannable code is on the refillable container.

In a preferred embodiment, the second scannable code is on a non-removable label associated with the refillable container.

In a preferred embodiment, the first scannable code and the second scannable code are universal product codes.

In a preferred embodiment, the first scannable code is also indicative of an initial filling of the container.

In a preferred embodiment, the readable object has an initial condition representing the first condition and is modifiable to have a subsequent condition representing the second condition.

In a preferred embodiment, the identifier is a readable object.

In a preferred embodiment, the readable object associated with the refillable container is also indicative of an initial filling of the container.

In a preferred embodiment, the readable object is a smart chip.

In a preferred embodiment, the smart chip is also capable of holding information related to the date on which the refillable container is filled.

In a preferred embodiment, the readable object is capable of holding information related to whether the refillable container has been previously filled with the product.

In a preferred embodiment, the readable object is modified from being representative of the first condition to being representative of the second condition.

In a preferred embodiment, the readable object is modified from the first condition to the second condition by writing information to the readable object.

In a preferred embodiment, the readable object is modified from the first condition to the second condition by the writer in conjunction with the filling of the refillable container dependent at least in part on the data is indicative of the refillable container having been filled in the past.

In a preferred embodiment, the invention further removes the removable label in connection with a first sale of the refillable container following scanning the first scannable code.

In a preferred embodiment, the invention further modifies the readable object from being representative of the first condition to being representative of the second condition.

In a preferred embodiment, the invention further writes information to the readable object.

In a preferred embodiment, the readable object is modified from the first condition to the second condition in conjunction with the filling step dependent at least in part on the data being indicative of the refillable container having been filled in the past.

### BRIEF DESCRIPTION OF THE DRAWING

FIG. 1 is a schematic of the dispenser of the present invention.

FIG. 2 is a schematic of a close-up of a fill station of the present invention.

FIG. 3 is a block diagram illustrating placing the concentrate containers at a site remote from the dispenser.

FIG. 4 is a block diagram of a system of one embodiment of the invention;

FIG. 5 illustrates a container according to another embodiment of the invention;

FIG. 6 is a close-up illustration of a portion of a container having a first label having a scannable code used in conjunction with the invention;

FIG. 7 is a close-up illustration of a portion of a container having a second label having a scannable code used in conjunction with the invention;

FIG. 8 is a close-up illustration of a portion of a container having a scannable code used in conjunction with the invention;

FIG. 9 is a close-up illustration of a portion of a container having a smart chip used in conjunction with the invention;

FIG. 10 is a flow chart illustrating one embodiment of the invention;

FIG. 11 is a flow chart illustrating a second embodiment of the invention; and

FIG. 12 is a flow chart illustrating a third embodiment of the invention.

### DETAILED DESCRIPTION

The dispenser apparatus of the current invention and the method for filling containers of the current invention has many different features and steps. There are a number of different products which may be dispensed in the present invention. A list of at least some of the products envisioned being dispensed in the present invention include laundry detergent, pot and pan detergent, automatic dish machine detergent, window cleaners, hard surface cleaners, bathroom cleaners, toilet cleaners, floor cleaners, car cleaners and other car care products, concrete cleaners, kitchen and sink cleaners, tile cleaners, shower cleaners, and other household types of cleaners. The foregoing is not an exhaustive list. Any product may be dispensed that can be made from a concentrate and be diluted to a ready to used product.

The dispensers of the present invention may typically be located in supermarkets, warehouse clubs, building supply stores, convenience stores, mass merchandisers, or any other store that typically sells detergents and cleaners. The dispensers could be placed alongside the competing products, or at the end of a row containing the cleaners or sanitizers.

The present invention has many advantages. One advantage is there is less product being shipped to the various stores. Since only the concentrated product is being shipped, and the product is being diluted with water available at the store, less product is shipped. This results in lower shipping costs. Another advantage is the fill containers or concentrate containers may be reusable, thus the same container could be brought in a number of times and refilled or in the case of the concentrate container, the container could be sent back to the plant for refill of the concentrate, thus reusing the totes or drums. This has the pro-environmental aspect of recycling containers while using less fuel for shipping. The fill containers also may be collapsible; thus they could be shipped in a collapsed form which would reduce the volume of the products being shipped. These features and others result in an environmentally friendly product which could be priced lower than competitive products, thus providing a cheaper product for the consumers, as well as increased profit for the supermarket or store owner.

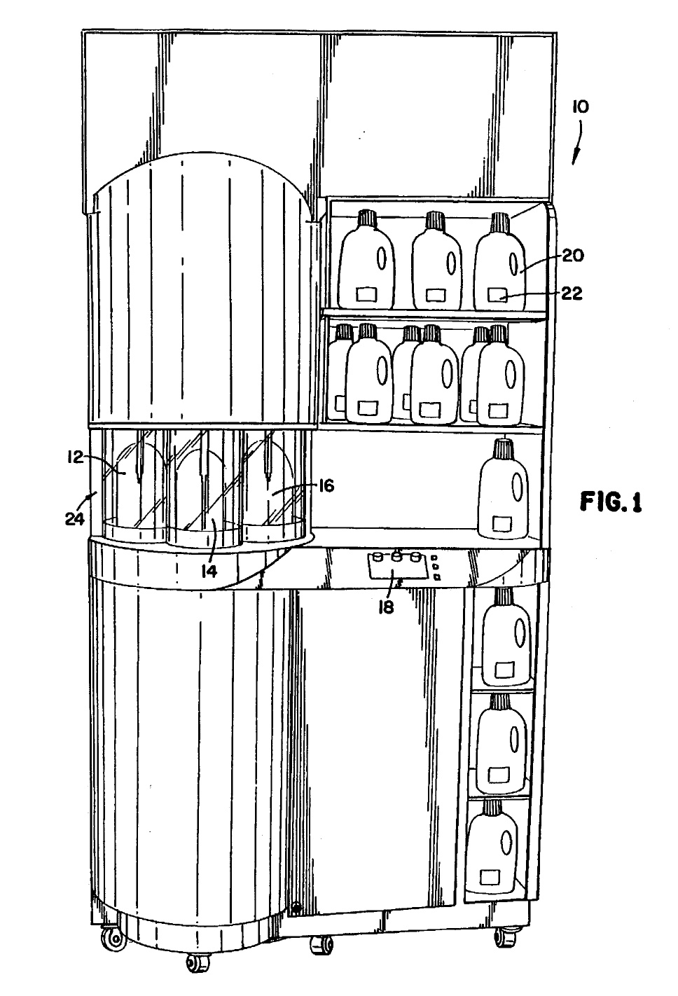

The present invention, which is shown in FIGS. 1, 2 and 3, discloses a dispenser 10 having filling stations 12, 14 and 16, and information screen 18. Each individual filling station typically will have a source of concentrated product as well as a source of water, or the two materials could be delivered to the filling station as a premixed single material. The filling station also will have some marking indicating what type of product it is associated with. Thus, in one embodiment of the present invention, a container 20 is placed in the filling station 12, wherein a concentrated product is filled into the container 20, either already diluted or followed with a diluting step of adding water after the concentrate has been added. The premixing may occur in a reservoir or inline prior to filling the container. Typically, there will be large reservoirs of concentrated product located within the dispenser or in a room located away from the dispenser. For the purposes of this invention, placing the concentrate containers away from the dispenser will be referred to as being in a “remote site.” A remote site will be a site usually some distance from the distance, usually out of sight of the users of the dispenser such as a back room. However, it could include being located on the other side of a wall, or in another aisle. As another option, the concentrates may be contained in a separate housing from the fill station, as in the remote site, but could be located next to or under the filler station or anywhere which is not at the dispenser.

These reservoirs will contain a concentrated product form of the product being dispensed. The concentrate can be a solid, liquid, paste, granular or liquid. Liquid is preferred. For example, if a pot and pan detergent is being dispensed, there may be a 5-gallon container of concentrated liquid pot and pan detergent in the dispenser or in a back room, wherein there will be some means to pump or pull a portion of the pot and pan concentrate from the container to the filling station. The use of a back room removes any practical limits to the size of the containers, and it is envisioned there may be 10-gallon or 55-gallon drums of concentrate located in an adjacent area, which is thereafter pumped to the dispenser and ultimately to the filling station.

In one embodiment of the present invention, a user would select a container 20 which may have some label 22 on it indicating what type of product will be filled within the container. The label 22 could include a UPC bar code, spot mark, or photo recognition of the container to identify the product, size and other information. Thus, as shown in the figures, a non-limiting example could be one fill station 12 dispensing a pot and pan detergent, another fill station 14 dispensing a window cleaner, and a third fill station 16 dispensing an all-purpose cleaner. There may be available alongside the dispenser 10 or attached to the dispenser 10, a variety of containers 20 with different labels associated with the type of product to be dispensed into the container. A user would select the desired product container and place it in one of the filling stations. The filling stations and/or product label may be color-coded or shape coded to assist the user in knowing which filling station to use. Additionally, the filling station may have a matching label with the product. As another alternative, the filling station would read what type of container is in the filling station, using bar codes, container configuration, or other sensing means. This would permit for using only one filling station. After the product is determined by the bottle selection and the reading of the UPC code when the bottle is placed in the filling station, the filling station would select the proper fill nozzle to fill the container with the proper product. The container itself could have molded into it some type of identifier such that when it is placed in the filling station, the filling station recognizes that particular container.

The filler station may also be equipped with an arm to receive the container to be filled and move the container to the proper position to be filled. Holding the container in this position until it is filled and the return it to the customer by moving it out of the filler back to easy reach of the customer.

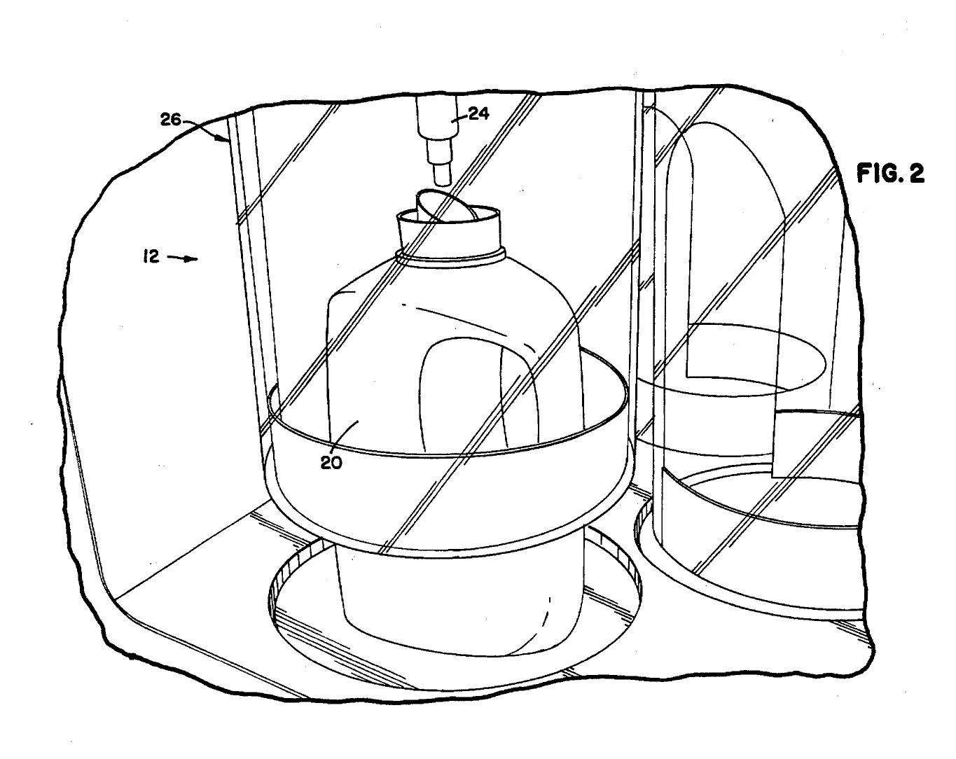

As is shown in FIG. 2, at the filling station 12, a nozzle 24 lowers, and begins filling the container 20 with the concentrated product. Concurrent with this, the same nozzle could be dispensing a source of water, or a second nozzle may be lowered into the container to fill with water. The preferred mode is to premix the diluent (typically water) with the concentrate prior to introduction to the container. This premixing could occur at the remote site or at the dispenser or in the piping between the two.

There are many safety features that can be included in the present invention. A shield 26 maybe lowered around the container prior to dispensing the product into the container. This shield 26, preferably transparent, would prevent product from spraying out on the customer or floor in the event there is a malfunction in the nozzle or the container tipped over. This shield 26 could have a safety mechanism wherein if the shield 26 sensed something in its path, it would raise again thus preventing someone's hand or body part from getting pinched or crushed by the shield.

Another safety feature could be at each filling station, there would be perforations holes or drains at the bottom of each filling station wherein spilled product will flow into either a holding tank or directed to a drain in the facility holding the dispenser. When the holding tank is filled, an automatic level switch could be used to shut the filling station down to prevent a spill of product.

Another possible feature of the dispenser could include a particular footprint for each container, wherein it would be very difficult to put the wrong container in the wrong fill station. For instance, the footprint of one container could be a triangle, the second container could be a square, and the third container could have a circular footprint or base. The dimensions of these could be set such that the wrong container could never be put in the fill station due to the footprint of the container not matching the recess in the fill station. Additionally, there could be projections either extending from the fill station or from the container which would have to be matched up in a lock and key-type configuration otherwise the container would not fit. Further, one fill station may have multiple footprints. That is, the fill station may have multiple level footprints of different shapes superimposed on each other to provide for centering of different shaped/sized containers. Also, changes in the footprint of the bottles along with the UPC code could be used for identification to fill different sized container for different products.

As shown in FIG. 1, there could be a separate screen 18, which may have a separate keypad or which may be a touch sensitive screen. For one embodiment, the screen could be a touch screen wherein the user would select the product at the screen level. Additionally, the screen could display instructions, information about the products, advertising, or any other information that may be desirable to be communicated to the user. The financial advantages of the dispensed product versus the competitive products could be compared, with the daily prices of each being entered in a manner similar to the entry of prices into the stores scanner system. Thus if a competitive product was on sale, the comparison could be adjusted, and even the price of the dispensed product could be automatically lowered to better compete against the competitive product. In this way, the dispensed product could be programmed to always be more economical than the competing product. So every time the competing product went on sale, the dispensed product would decrease in price accordingly. The system could also be interacted with online or electronically from a distant location to change pricing, advertising, troubleshooting or monitor sales.

The present invention could utilize one fill station, or many fill stations. One fill station could dispense different products, through the use of additional nozzles, or compatible products could be dispensed through the same nozzle/hose wherein any residual product being dispensed into another product would not have a negative impact on the performance or quality of the product. These products are hereinafter referred to as “nozzle compatible products.”

As an alternative, each fill station could include a nozzle wherein two tubes are directed into the nozzle, one containing the concentrate and the other containing a source of water. To increase the speed at which the containers may be filled, both the concentrate and the water could be dispensed into the container at the same time. As another alternative, the water could be added first followed by the concentrated product, or the concentrated product could be added first, followed by the water, or the two could be mixed very quickly in a separate reservoir located near the fill station. Thereafter, the reservoir could be dispensed or dumped into the container quickly.

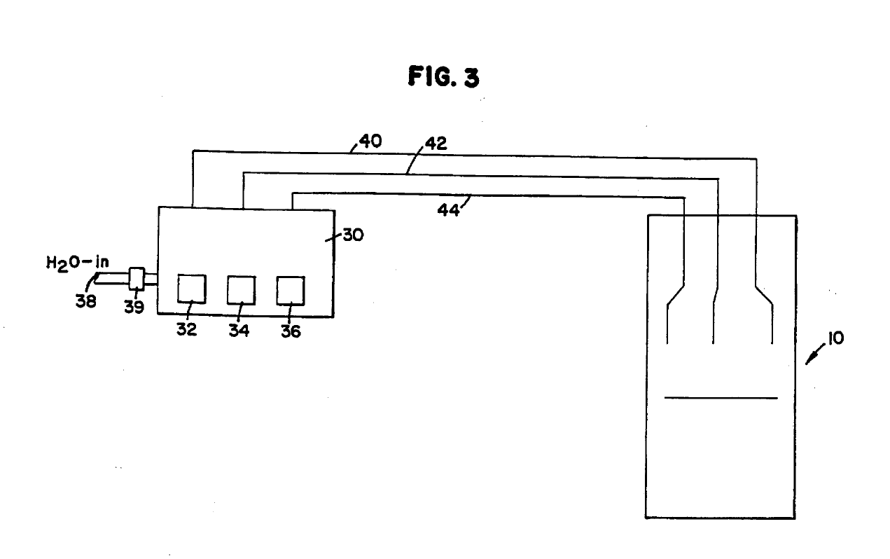

FIG. 3 shows an embodiment wherein concentrated products are located in a remote site from the dispenser. In FIG. 3, it is envisioned that the concentrated products would be in drums or large containers located in a single station shown as 30 which typically may be in the back room of a supermarket or mass merchandiser. There may be three concentrated products 32, 34 and 36. There also will be an inlet 38 for diluent, such as water, into station 30. In station 30, mixing would occur between the concentrated product and the diluent, which would thereafter be delivered, to the dispensing system in hoses or pipes 40, 42 and 44. Thereafter, a customer would use the dispenser 10 in the manner described herein.

The mixing which occurs in station 30 could be through the use of an aspirator, and could be a done in a mixing reservoir, or could merely be both introduced through a series of pumps into the corresponding pipe to be delivered to the dispenser 10. The advantage of having the storage and/or mixing away from the dispenser is multi-fold. The first advantage is larger containers could be put in a back stock room than typically could be placed in or adjacent to the dispenser. Thus, a typical dispenser may only be able to hold beneath it three 5-gallon pails of concentrated product, wherein a 10 or 55-gallon drum could be used in a back room. This would minimize the number of times store personnel would have to re-tap a new concentrated product. Another advantage is any potential spillage which may occur from time to time as a result of the storage of the concentrated products and/or mixing would be a back room, rather than in the store front. Having the larger concentrated products in the backroom also facilitates the ease of the delivery of the product and minimizes the movement of the product from the shipping dock to the store. Also, more products may be dispensed in a given in store space by having the dispenser 30 in a remote site. Further, there are fewer connections in the store when the dispenser is in the remote site.

The present invention can easily be modified to change products based on varying local geographic needs. For example, in areas where environmental concerns may be of particular importance, the products may be blended using environmental friendly ingredients. Water quality also varies throughout the country and the recipes for making the products may change based on water hardness, water pH, iron level of the water, etc. Thus, the formula in one geographic for detergent may differ from a dish detergent for a different geographical area. The product selection could vary, depending on local preferences. Buying preferences such as window cleaners, liquid pot and pan detergents, and all-purpose cleaners vary geographical, thus the availability of these products could be changed. Choice of fragrances also is local specific, so different fragrances could be used in different geographical locations.

Finally, a single dispenser 10 could be used to dispense many types of products, all from a single dispenser. This dispenser may dispense 20 or 30 different types of products, wherein there is a rinse of the lines between each of the dispensing. It is envisioned that a window cleaner could be dispensed. A brief cleaning of the lines would occur which would be followed by the dispensing of a laundry detergent. The cleaning of the lines could be achieved by a pure water rinse, or may involve some cleaner or method which would not contaminate the various products dispensed through the lines.

In the areas wherein there are water hardness problems, a pretreatment step could be implemented wherein the water would be softened, filtered or otherwise conditioned prior to diluting the concentrated product. This could be achieved easier if all of the mixing and the location of the concentrated products was in a remote site. A pretreatment apparatus 39, such as a water softener, is in fluid communication with the inlet 38 and with the dispenser 30.

The container shown as 20 could come in a variety of sizes. These sizes could be matched with the product being dispensed therein. An additional smaller bottle which could be filled from the larger bottle could also be attached to the larger container. Thus, the main container 20 could be sized to receive 1 or 2 liters of a product, wherein a small squirt attached bottle would be attached to the container such that when the consumer brought the product home, the consumer could pour from the larger bottle into a small, easier to handle bottle, such as a ½ liter bottle.

The top of the containers could include a wide variety of tops or caps. Examples include but are not limited to a spray nozzle, a squirt nozzle, or a one way valve which the nozzle would penetrate and fill, afterward pulling out. This one way valve could be thereafter opened by the consumer by different mechanisms. The key of the top is it must not leak or drip, and may be put on by easily the user or automatically by the dispenser.

In one embodiment of a method of using the dispenser 10, the method may be used if the concentrates are in the dispenser 10, as shown in FIG. 1 or utilizing a mixing station 30 as shown in FIG. 3. The method includes providing a retail product, obtained from a concentrate as previously described, to a consumer from a retail store operated by a retailer. The retail product is in a liquid form as is made from a concentrate. The retail product is an alternative to a pre-filled product sold at a retail store at a pre-filled price. The method includes the steps of supplying a concentrate, such as the concentrated products 32, 34 and 36 to the retail store. Water, to dilute the concentrate, is obtained locally with respect to the retail store. That is, the water is not shipped in to the retail store. The obtaining of the water locally is a major cost savings in that water does not have to be shipped in. If there are local conditions with the water, they may be handled by a water conditioning step as will be described more fully hereafter. As previously described, the container is filled at the retail store with the retail product using a combination of the concentrate and water. The retail product is sold at a retail price which is below a pre-filled price. The retailer is provided a portion of the retail price. The portion of the retail price is larger than a portion of a pre-filled price available to the retailer for sales of the pre-filled product. Because of the cost savings available from use of the dispenser 10, the retailer is able to make more money from the sale of the retail product from the dispenser 10 than from the sale of a ready-to-use product that the retailer would normally buy from its supplier.

The locally-obtained water may optionally be conditioned, such as by filtering or softening to provide for a more suitable source of water to the dispenser 10. The filling is accomplished by the consumer and is accomplished at a retail kiosk in the retail store. The retail kiosk being, for example, the dispenser 10 as shown in FIG. 1. The concentrate from which the retail product is made is preferably a liquid concentrate, although other concentrates, as previously discussed, may be utilized. Further, the product is preferably a cleaning product.

As previously discussed, promotional material is able to be provided to the consumer during the filling step from the retail kiosk through the screen 18. This information is able to be provided to the consumer while the filling step is being accomplished. Therefore, while the consumer is waiting for the container 20 to be filled, with idle time available to the consumer, the promotional material is provided at a time when the consumer is more likely to observe the promotional material.

System 50 utilized in a commercial establishment is illustrated in FIG. 4. Dispenser 10 and at least one container 20 is utilized with checkout reader 52 to enable a system in which a user can select a container 20 and have container 20 filled with a product at a filling station (12, 14, 16) in dispenser 10. The user may then take container 20, having been filled with product, to checkout in order to pay for container 20 and the product contained in container 20. Identifier 54, having a first condition, is recognized at checkout by reader 52 to properly initially filled price container 20, containing product, for the user. After utilizing the product from container 20, the user may return container 20 to the commercial establishment, or another commercial establishment also having a dispenser 10, and have container 20 refilled at dispenser 10. The user again takes container 20, this time containing more product, to checkout. Identifier 54, this time having a second condition, is again recognized by reader 52 to properly price re-filled container 20. It is expected that the refill price would be less than the initially filled price both because the user would have already paid for container 20 and, hence, would only be purchasing the product contained in container 20 and as an incentive for the user to bring previously filled container 20 back for refilling. This technique is friendly to the environment because more raw materials and energy would not be consumed to create another container 20 to replace the previous container 20 otherwise thrown away by the user.

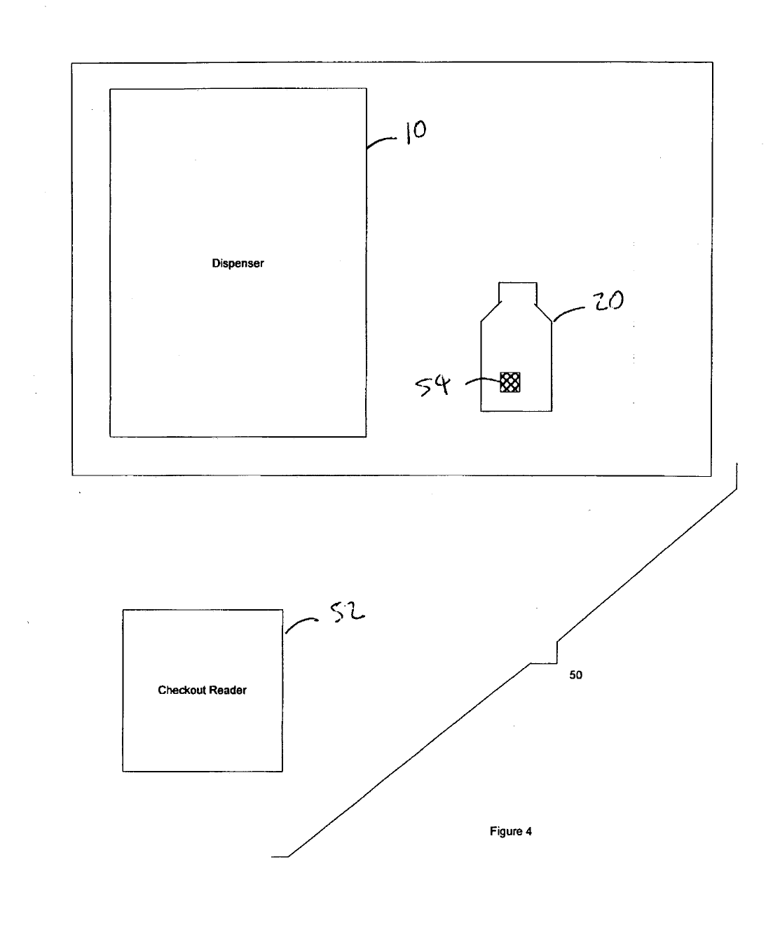

Refillable container 20 (FIG. 5) is associated with identifier 54. While shown as on or affixed to container 20, it is recognized and understood that identifier 54 could otherwise be associated with container 20, such as by a hanging tag, associated packaging or carrier. Identifier 54 has a first condition recognizable by reader 52 and indicative of a pricing structure which includes the price for container 20. Such pricing structure may also include not only the price for container 20 but also the price for the product contained in container 20. Identifier 54 also has a second condition recognizable by reader 52 and indicative of a pricing structure which includes the price for refilling container 20. Such a pricing structure may, of course, exclude the price for container 20 since container 20 has already been previously purchased. It is recognized and understood that many other pricing structures are available including pricing structures in which container 20 is only partially priced in the first condition and is again partially priced in the second condition. These pricing structures are merely exemplary. The signification item is that, in this embodiment, identifier 54 can have two conditions, each associated with a different pricing structure.

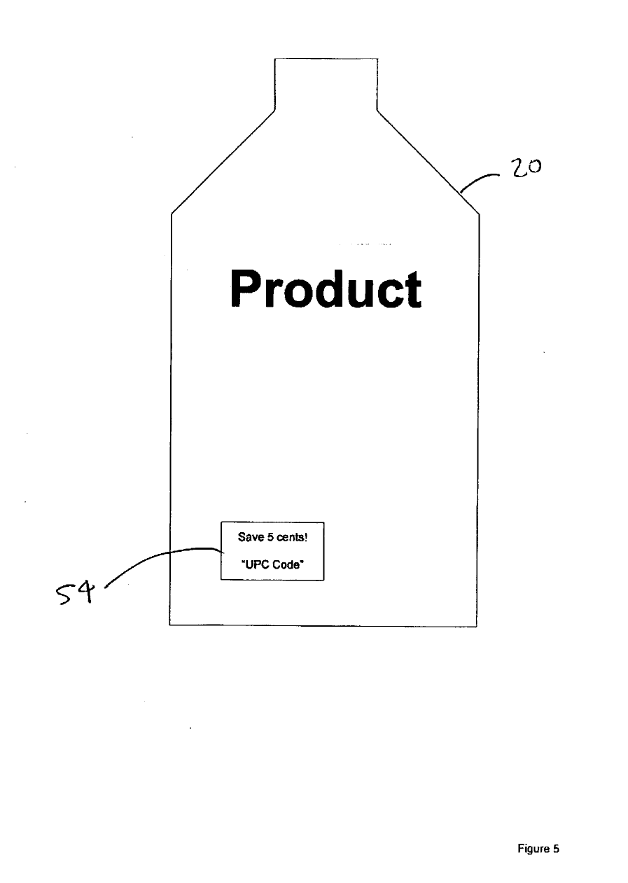

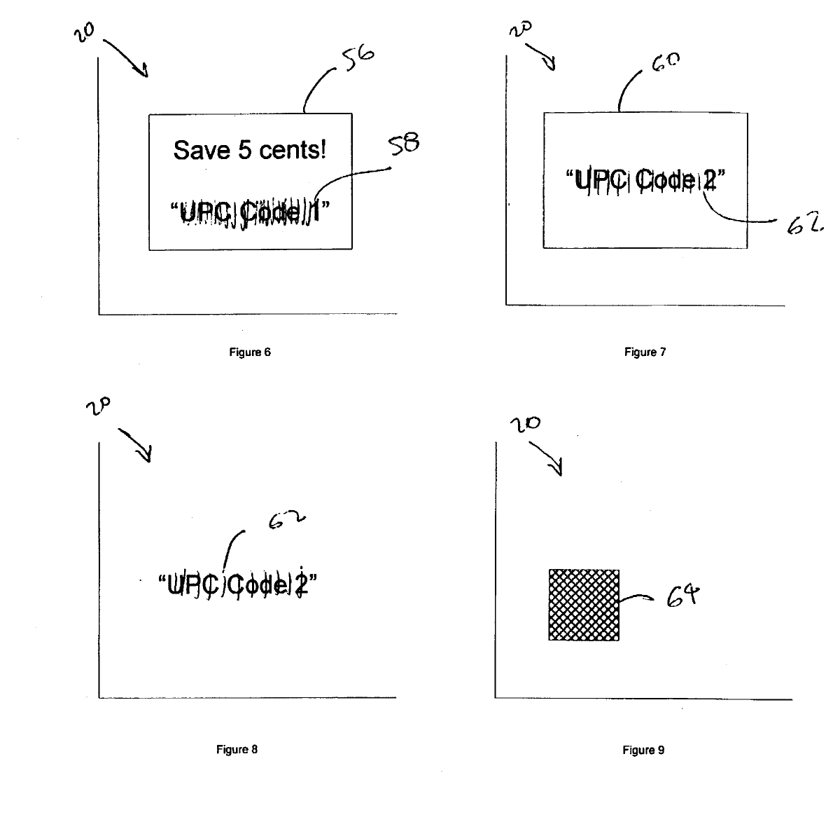

FIG. 6 and FIG. 7 show one embodiment of identifier 54 having two conditions. FIG. 6 illustrates a section container 20 having identifier 54. Identifier 54 in FIG. 6 is label 56 shown affixed to container 20 and having scannable code 58 readable therefrom. In this embodiment, scannable code 58 is a universal product code in the form of a bar code. Scannable code 58 is representative of the first condition of identifier 54. As can be seen in FIG. 7, a second label 60 is placed underneath top label. 56. That is, label 56 is superposed on top of label 60. Label 60 is also affixed to container 20 and has a scannable code 62 Scannable code 62 is representative of the second condition of identifier 54.

Label 56, placed on top of label 60, provides an outer scannable code 58 which provides the first condition for identification by reader 52. Label 60, placed underneath label 56, is not readable for reader 52. At some point during the process of filling, purchasing, using the product in container 20 and returning, re-filling and purchasing a refill of the product, label 56 is removed exposing label 60. Exposed label 60 is identifiable by reader 52 providing the second condition. In a preferred embodiment, label 56 is removed during checkout of container 56. In a further preferred embodiment, label 56 is removed during checkout of the initial sale of container 20 following identification by reader 52. As an incentive, label 56 may have a coupon printed thereon enticing both the user to purchase container 20 and also to facilitate removal of label 56 at initial checkout.

As an alternative to using labels, or a plurality of labels, or in addition to using a label or a plurality of labels, scannable code 58 may be modifiable into scannable code 62 through a variety of techniques which do not necessarily use a label for modification. As example would be an ink which is modifiable.

Scannable code 58 could be printed with a disappearing ink, either exposed directly or under an overlying label or coupon. At checkout, the label or coupon could be removed exposing the disappearing ink to the elements, or otherwise activating the disappearing feature of the ink, which would cause scannable code 58 to essentially disappear. Preferably, scannable code 58 would disappear over a period of time short enough so that when a customer came back to refill the container, scannable code 58 would have disappeared. Preferably, scannable code 58 would disappear in a matter of a few hours. As scannable code 58 disappears, scannable code 62 would remain associated with the refillable container, either positioned under scannable code 58, under a label or coupon, or otherwise becoming visible for use with the container when the container is refilled.

In another arrangement, scannable code 58 could be overprinted with another, initially transparent, ink which could be activated at checkout or at initial filling that would cover or otherwise obscure scannable code 58 following activation. Alternatively, scannable code 62 could be printed with an ink which would appear after activation, or could be covered (obscured) with an ink which disappears following activation revealing scannable code underneath. Again, activation could occur at initial filling or at initial checkout or a related process step along the way which would cause scannable code 58 to be available during initial checkout but would leave scannable code 62 available during subsequent refill checkouts.

FIG. 8 is an alternative embodiment for the second condition for identifier 54. Instead of printing scannable code 62 on a label which is affixed to container 20, in this embodiment, scannable code 62 is printed directly onto container 20 obviating the need for an underlying label. Otherwise, scannable code 62 operates similarly to scannable code 62 illustrated on label 60 in FIG. 7.

FIG. 9 illustrates another embodiment of identifier 54 used in association with container 20. Identifier 54 in FIG. 9 is a readable object, such as smart chip 64 (silicon chip and associated antenna), which can be either incorporated in, affixed to container 20 or other associated with container 20. Smart chip 64 is supplied with container 20 having a first condition readable by reader 52. Smart chip 64 is modifiable by conventional equipment, which could be used separately or incorporated into reader 52, to have a second condition also readable by reader 52. Smart chip 64 may be modified from the first condition and the second at any of the times and in any of the functions described above with respect to changing from scannable code 58 to scannable code 62.

In a preferred embodiment, smart chip 64 may modified in conjunction with the filling or refilling of container 20 in dispenser 10. For example, smart chip 64 could be stocked having the first condition. As container 20 is initially filled, information relating to the initial fill may be written to smart chip 64. While smart chip 64 is still identifiable in the first condition, smart chip 64 also contains information indicating that container 20 has been initially filled. When container 20 is again placed in dispenser 10 for refilling, dispenser 10 may read the information from smart chip 64 indicating that container 20 has been previously filled. Dispenser 10 may then modify the information contained in smart chip 64 to indicate the second condition to reader 52.

In a preferred embodiment, information is written to smart chip 64 by dispenser 10 indicative of the time, e.g., the calendar date, a sequential code or other identifier, that container 20 is filled. This information could then be subsequently retrieved as desired. This scenario may fulfill requirements in some jurisdictions requiring information placed on container 20 indicative of the date of filling. In an embodiment, the filling information written to smart chip 64 is the identifier indicating that container 20 has been previously filled.

Smart chip 64 and its reader 52 use well known, conventional technology. Such technology has been in existence and has been well know for use in other circumstances, such as, for example, credit and debit cards. This same technology may be employed in conjunction with container 20 and dispenser 10 to write to and modify smart chip 64. An example which could be used are radio frequency identification tags such as those marketed by CCI Label, Inc., and by Motorola, Inc., Schaumberg, Ill., using Motorola's BiStatix™ radio frequency identification technology.

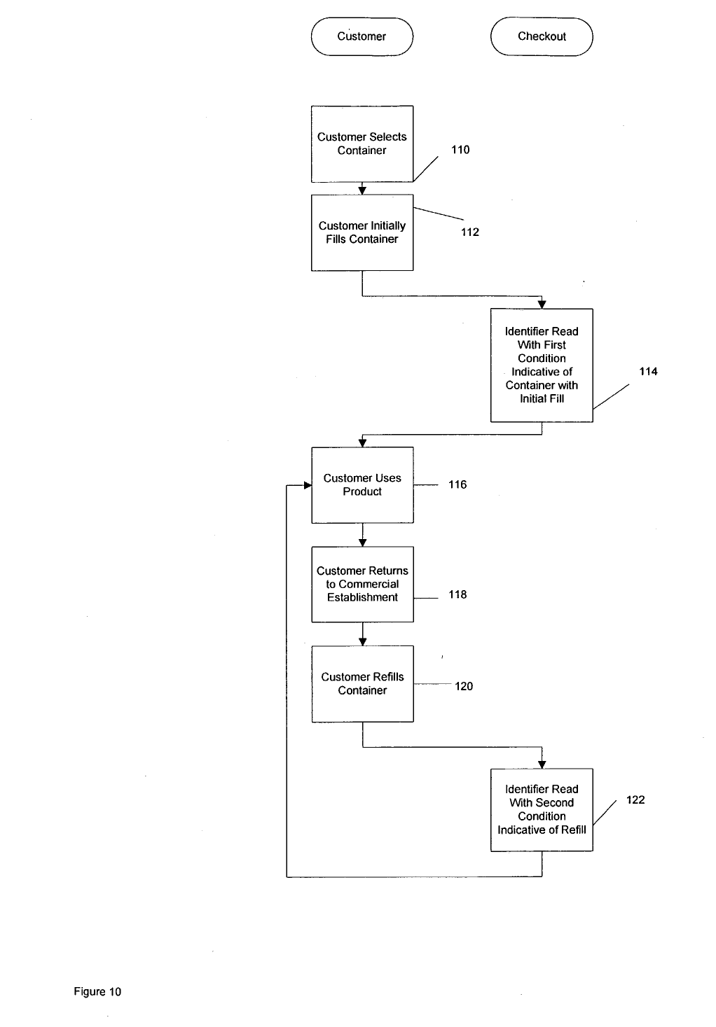

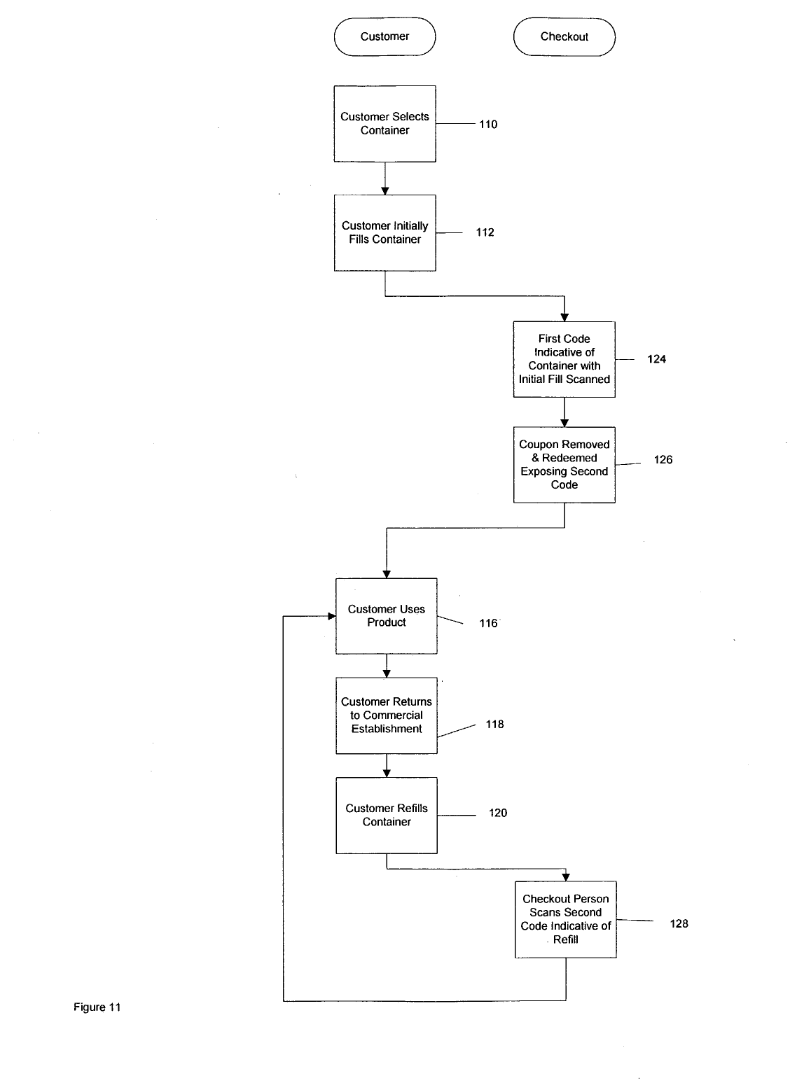

FIG. 10 is a flow chart which illustrates some of the basic concepts of an embodiment of the present invention. A customer selects (block 10) a container 20 from a rack at or near dispenser 10. The customer initially fills (block 112) container 20 using dispenser 10. Having filled container 20 with product, the customer proceeds to checkout (block 114) with container 20 having identifier 54 indicative of a first (initially filled) condition. Container 20 and product in container 20 are appropriately priced at checkout using the first condition read by reader 52. The customer then uses (block 116) the product in container 20 or otherwise has a need to refill container 20. The customer returns (block 118) to the commercial establishment and refills (block 120) container 20. The customer then takes (block 122) the refilled container 20 to checkout where identifier 54 is identified having the second condition indicative of having been refilled by reader 52.

FIG. 11 is a flow chart of an alternative embodiment of the invention. As in FIG. 10, a customer selects (block 110) a container 20 from a rack at or near dispenser 10. The customer initially fills (block 112) container 20 using dispenser 10. Having filled container 20 with product, the customer proceeds to checkout (block 124) with container 20 having coupon with scannable code 58 indicative of a first (initially filled) condition. Container 20 and product in container 20 are appropriately priced at checkout using the first condition scanned by reader 52. Label 56 containing coupon and scannable code 58 are separated (block 126) from container 20 exposing underlying label 60 having scannable code 62. The customer then uses (block 116) the product in container 20 or otherwise has a need to refill container 20. The customer returns (block 118) to the commercial establishment and refills (block 120) container 20. The customer then takes the refilled container 20 to checkout where scannable code 62 having the second condition indicative of having been refilled is scanned (block 128) by reader 52.

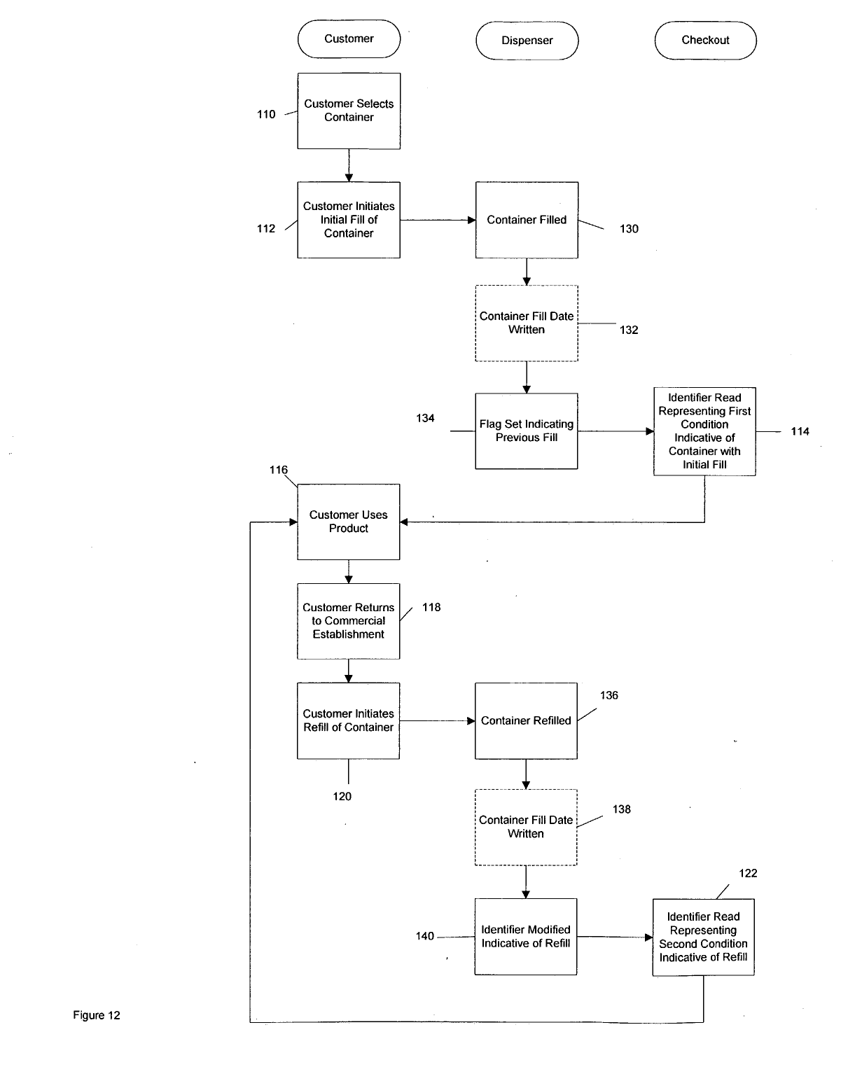

FIG. 12 is a flow of another alternative embodiment of the invention. A customer selects (block 110) a container 20 from a rack at or near dispenser 10. The customer initiates the filling (block 112) of container 20 using dispenser 10. Dispenser 10 fills (block 130). Optionally, dispenser 10 also writes (block 132) information to smart chip 64 indicative of the date of fill. A flag is set (block 134) in smart chip 64 indicating that container 20 has been initially filled. In one embodiment, the steps of blocks 132 and 134 could be the same step and the flag could information about the date container 20 is filled since, if container 20 had not been previously filled, the fill date information would be empty. Having filled container 20 with product, the customer proceeds to checkout (block 114) with container 20 having identifier 54 indicative of a first (initially filled) condition. Container 20 and product in container 20 are appropriately priced at checkout using the first condition read by reader 52. The customer then uses (block 116) the product in container 20 or otherwise has a need to refill container 20. The customer returns (block 118) to the commercial establishment and initiates refill (block 120) of container 20. Dispenser 10 then completes the filling (block 136) of container 20. Again optionally, the fill date is written (block 138) to smart chip 64. Since container has been previously filled, as determined by the flag set in block 134, smart chip 64 is modified (block 140) to be representative of the second condition. The customer then takes (block 122) the refilled container 20 to checkout where smart chip 64 is identified having the second condition indicative of having been refilled by reader 52.

Although the present invention has been described with reference to particular embodiments, it should be understood that those skilled in the art may make many other modifications to the present invention without departing from the spirit and scope of the invention which is defined by the appended claims.

What is claimed is:

1. A method of providing a retail product in a container to a consumer from a retail store operated by a retailer, said retail product being a liquid constructible from a concentrate, said retail product being an alternative to a pre-filled product sold at a retail store at a pre-filled price, comprising the steps of:
supplying said concentrate to said retail store;
obtaining water locally with respect to said retail store;
filling said container at said retail store with said retail product using a combination of said concentrate and said water;
selling said retail product to said consumer at a retail price; and
providing said retailer with a portion of said retail price, said portion of said retail price being larger than a portion of said pre-filled price available to said retailer for sales of said pre-filled product.

2. A method as in claim 1 which further comprises the additional step of conditioning said water, accomplished between said obtaining step and said filling step.

3. A method as in claim 1 wherein said filling step is accomplished by said consumer.

4. A method as in claim 3 wherein said filling step is accomplished at a retail kiosk in said retail store.

5. A method as in claim 4 wherein said concentrate is a liquid concentrate.

6. A method as in claim 5 wherein said retail product is a liquid product.

7. A method as in claim 6 wherein said liquid product is a cleaning product.

8. A method as in claim 4 which further comprises the additional step of providing promotional material to said consumer during said filling step and from said retail kiosk.

9. A method as in claim 3 which further comprises the additional step of providing promotional material to said consumer while said filling step is being accomplished.

10. A method of claim 1 wherein said retail product is sold at a retail price which is below said pre-filled price.

11. A refillable container adapted to be initially sold at a commercial establishment and subsequently be refilled at a commercial establishment, comprising:
a refillable container; and
an identifier associated with said refillable container, said identifier having a first condition indicative of said refillable container and a second condition indicative of refilling of said container.

12. A refillable container as in claim 11 wherein said identifier comprises:
a first scannable code associated with said refillable container indicative of said first condition; and
a second scannable code associated with said refillable container indicative of said second condition.

13. A refillable container as in claim 12 wherein said first scannable code is superimposed over said second scannable code.

14. A refillable container as in claim 12 wherein said first scannable code is on a removable label associated with said refillable container.

15. A refillable container as in claim 14 wherein said removable label is a coupon.

16. A refillable container as in claim 14 wherein said removable label is superimposed over said second scannable code.

17. A refillable container as in claim 14 wherein said second scannable code is on said refillable container.

18. A refillable container as in claim 14 wherein said second scannable code is on a non-removable label associated with said refillable container.

19. A refillable container as in claim 12 wherein said first scannable code and said second scannable code are universal product codes.

20. A refillable container as in claim 12 wherein said first scannable code is also indicative of an initial filling of said container.

21. A refillable container as in claim 11 wherein said identifier comprises a readable object.

22. A refillable container as in claim 21 wherein said readable object has an initial condition representing said first condition and is modifiable to have a subsequent condition representing said second condition.

23. A refillable container as in claim 22 wherein said readable object associated with said refillable container is also indicative of an initial filling of said container.

24. A refillable container as in claim 22 wherein said readable object is also writable.

25. A refillable container as in claim 24 wherein said readable object is a smart chip.

26. A refillable container as in claim 25 wherein said smart chip is also capable of holding information related to the date on which said refillable container is filled.

27. A system for providing a product in a refillable container at a commercial establishment, comprising:
a refillable container having an identifier associated with said refillable container, said identifier having a first condition indicative of said refillable container and a second condition indicative of refilling of said container;
a dispenser adapted to receive said refillable container and being capable of filling said refillable container with said product;
a reader capable of reading said identifier;
said system being configured such that said reader reads said identifier in said first condition when said refillable container is initially provided with said product and reads said identifier in said second condition when said refillable container is provided having been refilled with said product.

28. A system as in claim 27 wherein said identifier comprises:
a first scannable code associated with said refillable container indicative of said refillable container, and
a second scannable code associated with said refillable container indicative of refilling of said refillable container.

29. A system as in claim 28 wherein said first scannable code is superimposed over said second scannable code.

30. A system as in claim 28 wherein said first scannable code is on a removable label associated with said refillable container.

31. A system as in claim 30 wherein said removable label is a coupon.

32. A system as in claim 30 wherein said removable label is superimposed over said second scannable code.

33. A system as in claim 30 wherein said second scannable code is on said refillable container.

34. A system as in claim 30 wherein said second scannable code is on a nonremovable label associated with said refillable container.

35. A system as in claim 28 wherein said first scannable code and said second scannable code are universal product codes.

36. A system as in claim 28 wherein said first scannable code is also indicative of an initial filling of said container.

37. A system as in claim 27 wherein said identifier is a readable object having an initial state being representative of said first condition and a subsequent state being representative of said second condition.

38. A system as in claim 37 wherein said readable object is capable of holding information related to whether said refillable container has been previously filled with said product.

39. A system as in claim 37 wherein said readable object is modified from being representative of said first condition to being representative of said second condition.

39. A system as in claim 38 wherein said readable object is a smart chip.

40. A system as in claim 38 further comprising a writer adapted to write information to said readable object.

41. A system as in claim 40 wherein said readable object is modified from said first condition to said second condition by writing information to said readable object.

42. A system as in claim 40 wherein said information comprises data related a time of filling said container.

43. A system as in claim 42 wherein said writer is associated with said dispenser and wherein said data is written to said readable object in conjunction with said filling of said refillable container with said product.

44. A system as in claim 43 wherein said readable object is modified from said first condition to said second condition by said writer in conjunction with said filling of said refillable container dependent at least in part on said data is indicative of said refillable container having been filled in the past.

45. A system as in claim 37 wherein said readable object associated with said refillable container is also indicative of an initial filling of said container.

46. A method of providing a product in a refillable container at a commercial establishment, comprising the steps of:
providing said refillable container having an identifier associated with said refillable container having a first condition indicative of said refillable container and a second condition indicative of refilling of said refillable container;
initially filling said refillable container with said product;
reading said identifier being representative of said first condition and determining a price for said refillable container containing said product as a function of said first condition of said identifier;
refilling said refillable container with said product;
reading said identifier being representative of said second condition and determining a price for said refillable container containing said product as a function of said second condition of said identifier.

47. A method as in claim 46 wherein said identifier is a scannable code.

49. A method as in claim 46 wherein said first scannable code is superimposed over said second scannable code.

50. A method as in claim 46 wherein said first scannable code is on a removable label associated with said refillable container.

51. A method as in claim 50 wherein said removable label is a coupon.

52. A method as in claim 50 wherein said removable label is superimposed over said second scannable code.

53. A method as in claim 52 further comprises the step of removing said removable label in connection with a first sale of said refillable container following scanning said first scannable code.

54. A method as in claim 47 wherein said second scannable code is on said refillable container.

55. A method as in claim 47 wherein said second scannable code is on a non-removable label associated with said refillable container.

56. A method as in claim 47 wherein said first scannable code and said second scannable code are universal product codes.

57. A method as in claim 47 wherein said first scannable code is also indicative of an initial filling of said container.

58. A method as in claim 46 wherein said identifier is a readable object having an initial state being representative of said first condition and a subsequent state being representative of said second condition.

59. A method as in claim 58 further comprising the step of modifying said readable object from being representative of said first condition to being representative of said second condition.

60. A method as in claim 59 wherein said readable object is a smart chip.

61. A method as in claim 58 further comprising the step of writing information to said readable object.

62. A method as in claim 61 wherein said readable object is modified from said first condition to said second condition by writing information to said readable object.

63. A method as in claim 61 wherein said information comprises data related to a time of filling said container.

64. A method as in claim 63 wherein said data is written to said readable object in conjunction with at least one of said filling step and said refilling step.

65. A method as in claim 61 wherein said readable object is modified from said first condition to said second condition in conjunction with said filling step dependent at least in part on said data being indicative of said refillable container having been filled in the past.

66. A method as in claim 58 wherein said readable object associated with said refillable container is also indicative of an initial filling of said container.
